(19) United States
(12) Patent Application Publication
(10) Pub. No.: US 2026/0131273 A1
(43) Pub. Date: May 14, 2026

(54) FILTER ASSEMBLY

(71) Applicants: Hyundai Motor Company, Seoul (KR); Kia Corporation, Seoul (KR); Freudenberg Vilene Filtration Technologies Korea Co., Ltd., Pyeongtaek (KR)

(72) Inventors: Gun Woo Nam, Hwaseong (KR); Jung Hwan Yoon, Hwaseong (KR); Dong Kwan Kim, Pyeongtaek (KR); Byung Yeon Park, Pyeongtaek (KR)

(21) Appl. No.: 19/175,714

(22) Filed: Apr. 10, 2025

(30) Foreign Application Priority Data
Nov. 11, 2024 (KR) 10-2024-0158889

(51) Int. Cl. B01D 46/52; B01D 46/00; B05B 16/00

(52) U.S. Cl. CPC B01D 46/523; B01D 46/0005; B01D 2265/06; B05B 16/00

(57) ABSTRACT

Provided is a filter assembly that resolves a high differential pressure between the front and rear ends of a filter and limitations in dust and paint collection performance due to an inefficient internal structure of the filter. The filter assembly includes a housing, a paper core filter received in the housing and folded in a zigzag shape, supports coupled to the paper core filter to maintain the shape of the paper core filter and support the paper core filter, and the supports includes a first support configured such that a plurality of plate members is coupled, and coupled to first regions configured such that air before filtration is introduced thereinto in the folded paper core filter, and second supports configured such that a plurality of plate members is coupled, and coupled to second regions configured such that air after filtration passes therethrough in the folded paper core filter.

### CROSS-REFERENCE TO RELATED APPLICATION

This application claims under 35 U.S.C. § 119(a) the benefit of Korean Patent Application No. 10-2024-0158889 filed on Nov. 11, 2024, the entire contents of which are incorporated herein by reference.

### BACKGROUND

### Technical Field

The present disclosure relates to a filter assembly that resolves a high differential pressure between the front and rear ends of a filter and limitations in dust and paint collection performance due to an inefficient internal structure of the filter.

### Background

Today, dry painting booths that do not use circulating water are used on automobile factory painting lines, in automobile A/S centers, and in other small and medium-sized painting factories. In the dry painting booths, a filter assembly is used to remove dust and paint from the air.

The filter assembly for dry painting booths includes a three-dimensional paper core filter that removes foreign substances by allowing air to pass therethrough it, and a housing that accommodates the paper core filter. A hexahedral housing may be used as the housing, and in this case, the overall shape of the filter assembly for dry painting booths may be a hexahedral shape. This hexahedral filter assembly is installed in a hexahedral space at the front end of an exhaust duct connected to a dry painting booth to remove dust in the air and paint moving to the exhaust duct.

However, the conventional filter assembly has a high differential pressure between the front and rear ends of the filter that is applied to the filter assembly due to a structure that interferes with air flow, and has limitations in dust and paint collection performance due to an inefficient internal structure of the filter.

The information disclosed in this Background section is intended to enhance understanding of the disclosure's background and may contain information that does not form part of the prior art known in this country to a person of ordinary skill in the art.

### SUMMARY OF THE DISCLOSURE

The present disclosure has been made in an effort to solve the above-described problems associated with existing technologies, and it is an object of the present disclosure to provide a filter assembly that resolves a high differential pressure between the front and rear ends of a filter and limitations in dust and paint collection performance due to an inefficient internal structure of the filter.

In one aspect, a filter assembly is provided comprising: a) a housing; b) a paper core filter received in an internal space of the housing and folded in a zigzag shape; and c) supports coupled to the paper core filter to maintain the shape of the paper core filter and support the paper core filter, wherein the supports comprise: i) a first support configured in a structure having a plurality of plate members and coupled to first regions of the paper core filter through which air before filtration is introduced; and ii) second supports configured in a structure having a plurality of plate members and coupled to second regions of the folded paper core filter through which air after filtration passes.

In some embodiments, the present disclosure provides a filter assembly including a housing, a paper core filter received in an internal space of the housing and folded in a zigzag shape, and supports coupled to the paper core filter to maintain the shape of the paper core filter and support the paper core filter, wherein the supports includes a first support configured in a structure in which a plurality of plate members is coupled, and coupled to first regions configured such that air before filtration is introduced thereinto in the folded paper core filter, and second supports configured in a structure in which a plurality of plate members is coupled, and coupled to second regions configured such that air after filtration passes therethrough in the folded paper core filter.

In some embodiments, a first surface, which is one of two surfaces of the paper core filter, may be a surface configured to come into contact with the air before filtration, a second surface, which is a remaining one of the two surfaces of the paper core filter, may be a surface configured to come into contact with the air after filtration, and the first support may be inserted into and coupled to the first regions, which is inner regions of the paper core filter formed by the first surface with the paper core filter folded in the zigzag shape as a boundary.

In some embodiments, the first support may be inserted into the first regions, which are spaces between two filter regions arranged with an interval through folding with folded parts of a rear end of the paper core filter as boundaries, and may be coupled to the first surface to come in contact therewith in the spaces between the two filter regions, so as to maintain the interval of the zigzag shape of the paper core filter while maintaining the zigzag shape of the paper core filter.

In some embodiments, the first support may include a plurality of layer members arranged to be spaced apart from each other to form a vertical multistage structure, a plurality of inclined plate members arranged in inclined directions to connect the layer members, first fixing members coupled to rear ends of the layer members and the inclined plate members to connect the rear ends of the layer members and the inclined plate members, and a second fixing member coupled to front ends of the layer members and the inclined plate members to connect the front ends of the layer members and the inclined plate members.

In some embodiments, two inclined members may be arranged in an X shape as the plurality of inclined members of the first support.

In some embodiments, the housing is provided in a hexahedral shape, and the two inclined members may be arranged diagonally between two corners of the housing in the internal space of the housing.

In some embodiments, through holes configured such that foreign substances filtered out of air pass therethrough to flow down may be formed through each of the layer members.

In some embodiments, in a state in which the plurality of layer members is arranged to form the vertical multistage structure, the through holes formed at corresponding positions of the layer members arranged in the vertical multistage structure may be arranged in a vertical straight line.

In some embodiments, through holes configured such that foreign substances filtered out of air pass therethrough to flow down may be formed through each of the inclined plate members.

In some embodiments, each of the first fixing members may be arranged to extend vertically in a space between two filter regions spaced apart from each other at each folded part of a rear end of the paper core filter.

In some embodiments, the second fixing member may be arranged to extend vertically while in contact with a folded part of a front end of the paper core filter.

In some embodiments, each of the layer members may be a plate member configured to have a plurality of receiving grooves arranged at a set interval in a longitudinal direction, and two filter portions of the paper core filter arranged at an interval through folding may be inserted into each of the receiving grooves.

In some embodiments, each of the inclined plate members may be a plate member configured to have a plurality of receiving grooves arranged at a set interval in a longitudinal direction, and two filter portions of the paper core filter arranged at an interval through folding may be inserted into each of the receiving grooves.

In some embodiments, the second supports may be inserted into and coupled to the second regions, which are inner regions of the paper core filter formed by the second surface with the paper core filter folded in the zigzag shape as a boundary.

In some embodiments, the second supports may be inserted into the second regions, which are spaces between two filter regions arranged at an interval through folding with folded parts of a front end of the paper core filter as boundaries, and may be coupled to the second surface to come in contact therewith in the spaces between the two filter regions, so as to maintain the interval of the zigzag shape of the paper core filter while maintaining the zigzag shape of the paper core filter.

In some embodiments, each of the second supports may include a plurality of layer members arranged to be spaced apart from each other to form a vertical multistage structure, and support members coupled to the plurality of layer members to connect the plurality of layer members.

In some embodiments, the support members may include a first support member coupled to rear ends of the plurality of layer members to vertically connect the rear ends of the plurality of layer members, and a second support member coupled to front ends of the plurality of layer members to vertically connect the front ends of the plurality of layer members.

In some embodiments, in a state in which the plurality of layer members is arranged to form the vertical multistage structure, through holes formed at corresponding positions of the layer members arranged in the vertical multistage structure may be arranged in a vertical straight line.

Ins some embodiments, a filter assembly configured for use in a painting booth is provided. The filter assembly includes a housing adapted to be installed in an airflow path of an exhaust duct in the painting booth; a paper core filter received in an internal space of the housing and folded in a zigzag shape; a first support coupled to the paper core filter so as to engage first regions of the paper core filter through which air to be filtered enters; and a plurality of second supports arranged in parallel, each second support coupled to second regions of the paper core filter through which air after filtration exits. The plurality of second supports is positioned side by side in the housing so as to form multiple filtration states in the paper core filter and thereby facilitate the flow of foreign substances to be discharged.

The first support and the plurality of second supports may be combined into a single removable unit by at least one coupling structure that interconnects the first support and the second supports, allowing the paper core filter and its supports to be replaced or removed from the housing as one integrated assembly.

As discussed, the method and system suitably include use of a controller or processer.

In another embodiment, vehicles are provided that comprise an apparatus as disclosed herein.

Other embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a perspective view showing a filter assembly according to one embodiment of the present disclosure;

FIG. 2 is an exploded perspective view of the filter assembly according to one embodiment of the present disclosure;

FIG. 3 is a perspective view showing a combined state between a paper core filter and supports in the filter assembly according to one embodiment of the present disclosure;

FIG. 4 is a perspective view showing the paper core filter in the filter assembly according to one embodiment of the present disclosure;

FIG. 5 is a perspective view showing a first support in the filter assembly according to one embodiment of the present disclosure; and

FIG. 6 is a perspective view showing second supports in the filter assembly according to one embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. Specific structural or functional descriptions set forth in the embodiments of the present disclosure will be merely exemplarily given to describe the embodiments depending on the concept of the present disclosure, and the embodiments depending on the concept of the present disclosure may be embodied in different forms. Further, the present disclosure should not be construed as being limited to the embodiments set forth herein, and it will be understood that the present disclosure includes all modifications, equivalents, or substitutes included in the spirit and technical scope of the disclosure.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “zigzag shape” used herein refers to a series of repeated folds forming alternating peaks and valleys along the paper core filter, providing an increased surface area for filtration relative to a flat sheet.

The term “paper core filter” used herein refers to a filter medium primarily composed of a paper-based material that is folded or otherwise formed to trap or separate foreign substances from an air stream.

The term ‘foreign substances’ used herein refers to materials such as dust, paint, overspray, or particulate matter carried by the airstream and separated from the air by the filter assembly.

Wherever possible, the same reference numbers will be used throughout the following description to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

The present disclosure relates to a filter assembly using a paper core filter, and more particularly, to a filter assembly capable of removing foreign substances in the air by allowing the air to pass through a paper core filter.

The filter assembly according to the present disclosure may be installed in a hexahedral space at the front end of an exhaust duct connected to a dry painting booth, and is configured to remove foreign substances, such as dust in the air, which is discharged from the dry painting booth to the exhaust duct, and paint, using the paper core filter.

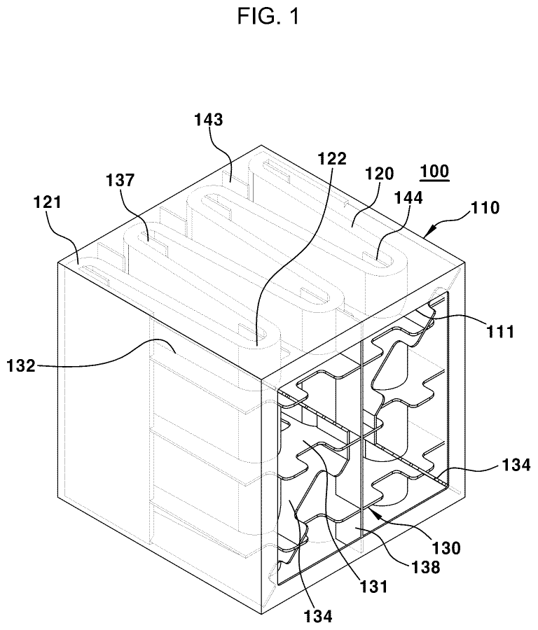

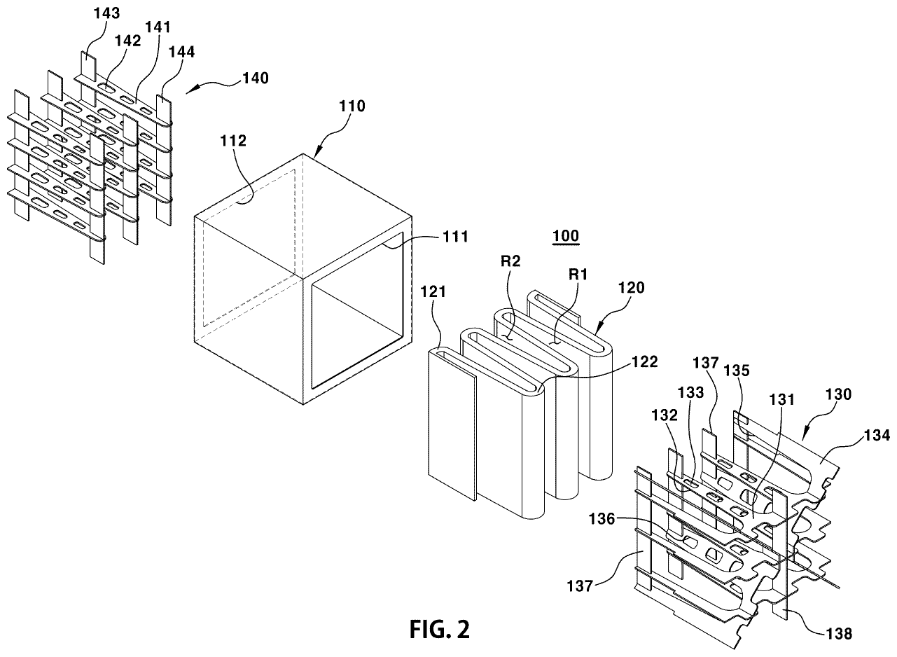

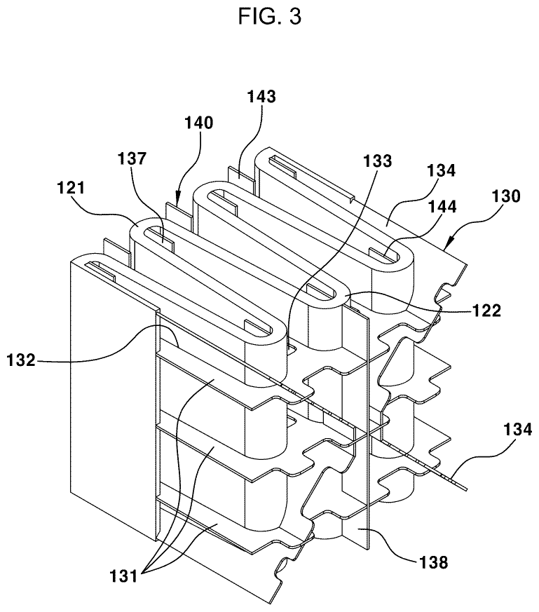

FIG. 1 is a perspective view showing a filter assembly according to one embodiment of the present disclosure, and FIG. 2 is an exploded perspective view of the filter assembly according to one embodiment of the present disclosure. FIG. 3 is a perspective view showing a combined state between a paper core filter and supports in the filter assembly according to one embodiment of the present disclosure.

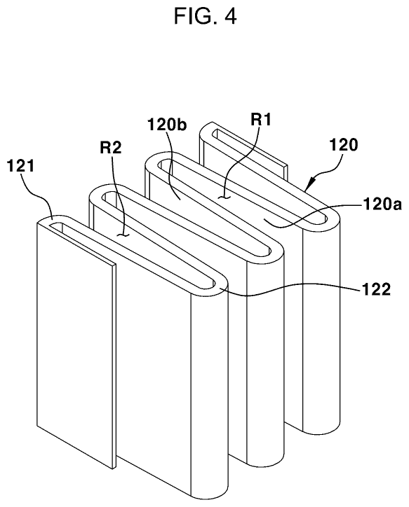

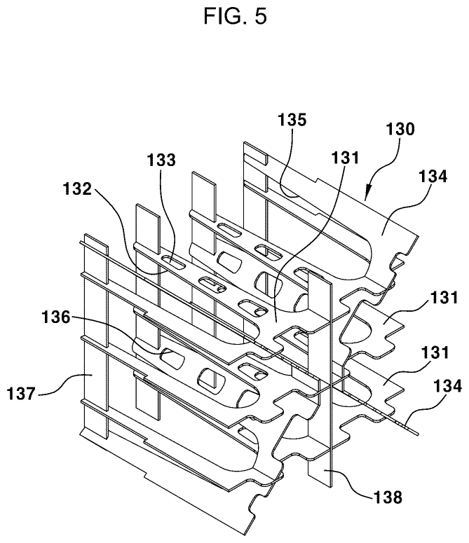

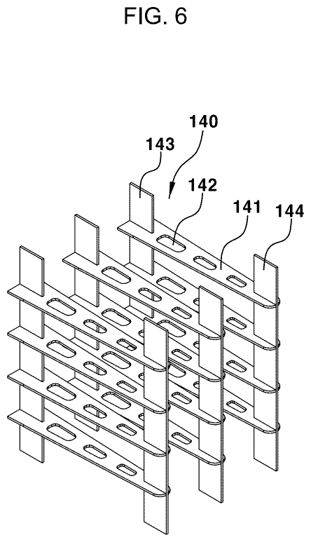

In addition, FIG. 4 is a perspective view showing the paper core filter in the filter assembly according to one embodiment of the present disclosure, and FIG. 5 is a perspective view showing a first support in the filter assembly according to one embodiment of the present disclosure. FIG. 6 is a perspective view showing second supports in the filter assembly according to one embodiment of the present disclosure.

A filter assembly 100 according to the present disclosure includes a housing 110, a paper core filter 120, and supports 130 and 140, and the supports 130 and 140 includes a first support 130 and second supports 140 that are combined with the paper core filter 120 interposed therebetween.

The housing 110 may be provided in a hexahedral shape to be installed in a hexahedral space at the front end (upstream side in an air flow direction and based on an air flow path) of an exhaust duct (not shown), and may be provided in a regular hexahedral box shape with a front surface (surface at the upstream side) and a rear surface (surface at the downstream side) that are open, as illustrated.

The internal space of the housing 110 is a receiving portion that receives the paper core filter 120 and the supports 130 and 140, which are integrally assembled and combined (see FIG. 1), and when air discharged from a dry painting booth (not shown) and then flowing to the exhaust duct is introduced into the receiving portion, which is the internal space of the housing 110, through a front opening 111 of the housing 110, the air passes through the paper core filter 120 and is then discharged through a rear opening 112 of the housing 110.

The paper core filter 120 is a filtering member that removes foreign substances in the air by allowing the air to pass therethrough, and may be a filtering member made of a paper material or a filtering material formed in the shape of a sheet made of a paper fabric of a predetermined thickness.

The paper core filter 120 may be provided in a shape in which a paper fabric is folded in opposite directions several times to form a zigzag shape. More specifically, as shown in FIG. 4, the paper core filter 120 may be provided in a shape in which a sheet-shaped paper fabric is folded in opposite directions of approximately 180° at respective transition portions 121 and 122 to form a zigzag shape.

A first surface 120a, which is one surface out of both surfaces of the paper core filter 120, comes into contact with air before filtration, and a second surface 120b, which is the opposite surface, comes into contact with air after filtration that has passed the paper core filter 120. Inner regions are present in bent portions of the paper core filter 120 due to the zigzag-shaped bent structure of the paper core filter 120.

That is, the inner regions formed by the first surface 120a among the inner regions of the bent portions of the paper core filter 120 become first regions R1 into which air before filtration flows, and the inner regions on the opposite side of the paper core filter 120, i.e., the inner regions on the opposite side, formed by the second surface 120b among the inner regions of the bent portions of the paper core filter 120 become second regions R2.

The paper core filter 120 serves as a main filter that filters out foreign substances from air by allowing the air passing therethrough, and the supports 130 and 140 serve as supports that maintain and support the bent shape of the paper core filter 120 and also serve as auxiliary filters that filter out foreign substances, such as dust, and liquid foreign substances, such as paint, to allow these foreign substances to flow down.

In one embodiment of the present disclosures, the supports 130 and 140 include the first support 130 inserted into and coupled to the first regions R1 and the second supports 140 inserted into and coupled to the second regions R2 among the inner regions of the bent portions of the paper core filter 120, i.e., spaces between parallel filter regions.

In one embodiment, the paper core filter 120 has a shape folded in opposite directions of approximately 180° at each of the transition portions 121 and 122 to form a zigzag shape, as described above. In the zigzag-shaped paper core filter 120, the first support 130 and the second supports 140 are inserted and coupled between two filter regions, which are disposed in parallel.

In one embodiment of the present disclosure, the spaces between the two filter regions spaced apart from each other in parallel with front transition portions 122 and rear transition portions 121, which are folded parts of the front end and the rear end of the zigzag-shaped paper core filter 120, as boundaries are the respective inner regions of the paper core filter 120, i.e., the first regions R1 and the second regions R2, into which the first support 130 and the second supports 140 are inserted.

The respective supports 130 and 140 serve to maintain intervals between the two filter regions (i.e., intervals of a zigzag pattern) of the paper core filter 120 disposed in parallel while securing the spaces between the filter regions, and simultaneously to maintain the zigzag pattern of the paper core pattern 120.

The first support 10 has a configuration in which a plurality of plate members is assembled, and includes a plurality of layer members 131 arranged horizontally and spaced apart from each other at a set interval in the vertical direction to form a vertical multistage structure, a plurality of inclined plate members 134 arranged in inclined directions to connect the layer members 131, a plurality of first fixing members 137 coupled to the rear ends of the layer members 131 to connect the rear ends of the layer members 131 vertically and arranged in the second regions R2 of the respective transition portions 121 and 122 of the paper core filter 120, and a second fixing member 138 coupled to the front ends of the layer members 131.

Among the above components, the plurality of layer members 131 may be arranged to be spaced apart from each other vertically at the set interval, for example, a constant interval, and the layer members 131 may be disposed approximately horizontally in the state in which they are spaced apart from each other vertically.

Each of the layer members 131 may be a plate member that is disposed horizontally. A plurality of through holes 133 through which foreign substances, such as dust in the air, or paint pass to flow down may be formed through each of the layer members 131.

A plurality of receiving grooves 132 into which the two filter regions arranged in parallel at the interval by folding the paper core filter 120 are respectively inserted to be coupled to the layer members 131 may be formed in each of the layer members 131. The plurality of receiving grooves 132 may be formed in each of the layer members 131 to be arranged at a set interval in the longitudinal direction.

Among the plurality of layer members 131, the through holes 133 formed through a lower layer member 131 may be formed to be arranged directly below the through holes 133 formed in an upper layer member 131, and thereby, the through holes 133 formed at corresponding positions of the layer members 131 provided in the multistage structure may be arranged in a vertical straight line.

When the folded parts of the paper core filter 120 including the respective transition portions 121 and 122 are inserted into the receiving grooves 132 of the respective layer members 131, the first surface of the inserted paper core filter 120 comes into contact with the inner edge of the receiving grooves 132.

The first fixing members 137 are members that are arranged to extend in the vertical direction to vertically connect the plurality of layer members 131. In this case, the first fixing members 137 are coupled to the rear ends of the respective layer members 131 to vertically connect the rear ends of the layer members 131 arranged in multiple stages.

The receiving grooves 132 of the respective layer members 131 of the first support 130 are located between two neighboring rear ends of the layer members 131 to which the first fixing members 137 are coupled.

The inclined plate members 134 are members that filter out foreign substances, such as dust contained in the air, and liquid foreign substances, such as paint, to allow these foreign substances to flow down, and are coupled to the layer members 131 arranged in the multiple stages to connect the layer members 131 in the inclined directions.

In one embodiment of the present disclosure, two inclined plate members 13 may be arranged and combined so as to intersect in an “X” shape. In this arrangement structure, when the paper core filter 120, the first support 130, and the second supports 140 are combined together and placed in the receiving portion of the housing 110, the two inclined plate members 134 may be arranged diagonally between two corners of the housing 110 in the receiving portion of the hexahedral housing 110.

In addition, a plurality of through holes 136 through which foreign substances, such as dust that has been contained in the air and then filtered out, and liquid foreign substances, such as paint, may pass may be formed through each of the inclined plate members 134.

Further, in the same manner as the layer members 131, a plurality of receiving grooves 135 into which the paper core filter 120 including the respective transition portions 121 and 122 are respectively inserted may be formed in the inclined plate members 134. The plurality of receiving grooves 135 may be formed to be arranged at a set interval in the longitudinal direction of the inclined plate members 134.

In addition, the rear ends of the inclined plate members 134 are connected and coupled to the first fixing members 137, and the receiving grooves 135 into which the paper core filer 120 is inserted is located between two adjacent rear ends of the inclined plate members 134 to which the first fixing members 137 are coupled, respectively.

In addition, the second fixing member 138 is coupled to the front ends of the layer members 131 and the inclined plate members 134, and in this case, is coupled to the front ends of the layer members 131 and the inclined plate members 134 so as to vertically connect the front ends of the layer members 131 and the front ends of the inclined plate members 134.

In one embodiment of the present disclosure, the second fixing member 138 may be arranged to extend vertically and may be coupled to the front ends of the laterally central positions of the layer members 131 and the inclined plate members 134.

Further, each second support 140 includes a plurality of layer members 141 arranged to be spaced apart from each other at a set interval (e.g., a constant interval) in the vertical direction to form a vertical multistage structure, and support members 143 and 144 coupled to the plurality of layer members 141 to connect the plurality of layer members 141.

In one embodiment of the present disclosure, a plurality of second supports 140 having the above configuration is provided, and the respective second supports 140 are inserted into the second regions R2 of the paper core filter 120. At this time, the respective second supports 140 are inserted into the second regions R2 between the respective parallel filter regions of the paper core filter 120 folded in the zigzag shape.

In one embodiment of the present disclosure, a plurality of through holes 142 through which foreign substances, such as dust filtered out from the air, or liquid foreign substances, such as paint, pass to flow down may be formed through the layer members 141 of the second support 140.

In one embodiment of the present disclosure, the support members 143 and 144 of each second support 140 include a first support member 143 coupled to one end of each of the plurality of layer members 141 arranged vertically so as to connect the ends of the plurality of layer members 141, and a second support member 144 coupled to the other end of each of the plurality of layer members 141 so as to connect the other ends of the plurality of layer members 141.

In the same manner as the first support 130, in the second support 140, among the plurality of layer members 141, the through holes 142 formed through a lower layer member 141 may be formed to be arranged directly below the through holes 142 formed in an upper layer member 141, and thereby, the through holes 142 formed at corresponding positions of the layer members 141 provided in the multistage structure may be arranged in a vertical straight line.

The respective components of the filter assembly 100 according to one embodiment of the present disclosure have been described in detail. The paper core filter 120, the first support 130, and the second supports 140 may be combined, as illustrated in FIG. 3, and the combined paper core filter 12, first support 130, and second supports 140 may be accommodated in the receiving portion, which is the internal space of the housing 110, as illustrated in FIG. 1.

Referring to FIG. 2, the hexahedral housing 110 having the front opening 111 and the rear opening 112 is illustrated. FIGS. 2, 3, and 4 illustrate the zigzag-shaped paper core filter 120 folded a total of 7 times in opposite directions of 180°, and it may be confirmed that the illustrated paper core filter 120 has a total of three front transition portions 122 and a total of four rear transition portions 121.

FIGS. 2, 3, and 6 shows a total of three second supports 140, and the three second supports 140 may be inserted into and combined with the second regions R2 between the parallel filter regions of the illustrated paper core filter 120 (see FIG. 3).

FIG. 5 is an assembled perspective view of the first support 130 in the filter assembly 100 according to one embodiment of the present disclosure, and illustrates the first support 130 configured by assembling three layer members 131, two inclined plate members 134, four first fixing members 137, and one second fixing member 138.

Referring to FIG. 3, in the filter assembly 100 according to one embodiment of the present disclosure, it may be confirmed that the second fixing member 138 supports the front transition portion 122 located in the middle among the three front transition portions 122 of the paper core filter 120.

As such, the configuration of the filter assembly 100 according to one embodiment of the present disclosure has been described in detail. In the filter assembly 100 according to one embodiment of the present disclosure, the paper core filter 120 and the supports 130 and 140 are configured in optimal shapes, structures, and arrangements suitable for capturing foreign substances, such as dust and paint, thereby enabling air flow passing through the paper core filter 120 to become smoother compared to conventional filter assemblies.

As a result, the filter assembly 100 according to one embodiment of the present disclosure may resolve not only a high differential pressure between the front and rear ends of the filter but also limitations in dust and paint collection performance due to an inefficient internal structure of the filter. In addition to collection performance improvement, there are advantages, such as filter lifespan extension, filter efficiency improvement, and improvement in ease of filter assembly.

As is apparent from the above description, in a filter assembly according to the present disclosure, a paper core filter and supports are configured in optimal shapes, structures, and arrangements suitable for capturing foreign substances, such as dust and paint, thereby enabling air flow passing through the paper core filter to become smoother compared to conventional filter assemblies, and thus being capable of resolving the conventional problem, which is a high differential pressure between the front and rear ends of the filter.

In addition, the filter assembly according to the present disclosure may resolve the other conventional problem, which is limitations in dust and paint collection performance due to an inefficient internal structure of the filter, and in addition to collection performance improvement, may have advantages, such as filter lifespan extension, filter efficiency improvement, and improvement in ease of filter assembly.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A filter assembly comprising:
a housing;
a paper core filter received in an internal space of the housing and folded in a zigzag shape; and
supports coupled to the paper core filter to maintain the shape of the paper core filter and support the paper core filter,
wherein the supports comprise:
a first support configured in a structure having a plurality of plate members and coupled to first regions of the paper core filter through which air before filtration is introduced; and
second supports configured in a structure having a plurality of plate members and coupled to second regions of the folded paper core filter through which air after filtration passes.

2. The filter assembly of claim 1, wherein:
a first surface, which is one of two surfaces of the paper core filter, is a surface configured to come into contact with the air before filtration;
a second surface, which is a remaining one of the two surfaces of the paper core filter, is a surface configured to come into contact with the air after filtration; and
the first support is inserted into and coupled to the first regions, which are inner regions of the paper core filter defined by the first surface and the fold lines of the zigzag shape.

3. The filter assembly of claim 2, wherein the first support:
is inserted into the first regions, which are spaces between two filter regions arranged with an interval through folding with folded parts of a rear end of the paper core filter; and
is coupled to the first surface in the spaces so as to maintain the interval and the zigzag shape of the paper core filter.

4. The filter assembly of claim 1, wherein the first support comprises:
a plurality of layer members arranged to be spaced apart from each other to form a vertical multistage structure;
a plurality of inclined plate members arranged in inclined directions to connect the layer members;
first fixing members coupled to rear ends of the layer members and the inclined plate members to connect the rear ends of the layer members and the inclined plate members; and
a second fixing member coupled to front ends of the layer members and the inclined plate members to connect the front ends of the layer members and the inclined plate members.

5. The filter assembly of claim 4, wherein the plurality of inclined members of the first support includes two inclined members arranged in an X shape.

6. The filter assembly of claim 5, wherein:
the housing is provided in a hexahedral shape; and
the two inclined members are arranged diagonally between two corners of the housing in the internal space of the housing.

7. The filter assembly of claim 4, wherein through holes configured such that foreign substances filtered out of air pass therethrough to flow down are formed through each of the layer members.

8. The filter assembly of claim 7, wherein, in a state in which the plurality of layer members is arranged to form the vertical multistage structure, the through holes formed at corresponding positions of the layer members arranged in the vertical multistage structure are arranged in a vertical straight line.

9. The filter assembly of claim 4, wherein through holes configured such that foreign substances filtered out of air pass therethrough to flow down are formed through each of the inclined plate members.

10. The filter assembly of claim 4, wherein each of the first fixing members is arranged to extend vertically in a space between two filter regions spaced apart from each other at each folded part of a rear end of the paper core filter.

11. The filter assembly of claim 4, wherein the second fixing member is arranged to extend vertically while in contact with a folded part of a front end of the paper core filter.

12. The filter assembly of claim 4, wherein each of the layer members is a plate member configured to have a plurality of receiving grooves arranged at a set interval in a longitudinal direction,
wherein two filter portions of the paper core filter arranged at an interval through folding are inserted into each of the receiving grooves.

13. The filter assembly of claim 4, wherein each of the inclined plate members is a plate member configured to have a plurality of receiving grooves arranged at a set interval in a longitudinal direction,
wherein two filter portions of the paper core filter arranged at an interval through folding are inserted into each of the receiving grooves.

14. The filter assembly of claim 2, wherein the second supports are inserted into and coupled to the second regions, which are inner regions of the paper core filter formed by the second surface with the paper core filter folded in the zigzag shape as a boundary.

15. The filter assembly of claim 14, wherein the second supports:
are inserted into the second regions, which are spaces between two filter regions arranged at an interval through folding with folded parts of a front end of the paper core filter as boundaries; and
are coupled to the second surface in the spaces, so as to maintain the interval and maintain the zigzag shape of the paper core filter.

16. The filter assembly of claim 15, wherein each of the second supports comprises:
a plurality of layer members arranged to be spaced apart from each other to form a vertical multistage structure; and
support members coupled to the plurality of layer members to connect the plurality of layer members.

17. The filter assembly of claim 16, wherein the support members comprise:
a first support member coupled to rear ends of the plurality of layer members to vertically connect the rear ends of the plurality of layer members; and
a second support member coupled to front ends of the plurality of layer members to vertically connect the front ends of the plurality of layer members.

18. The filter assembly of claim 17, wherein, in a state in which the plurality of layer members is arranged to form the vertical multistage structure, through holes formed at corresponding positions of the layer members are aligned in a vertical straight line.

19. A filter assembly configured for use in a painting booth, the filter assembly comprising:
a housing adapted to be installed in an airflow path of an exhaust duct in the painting booth;
a paper core filter received in an internal space of the housing and folded in a zigzag shape;
a first support coupled to the paper core filter so as to engage first regions of the paper core filter through which air to be filtered enters; and
a plurality of second supports arranged in parallel, each second support coupled to second regions of the paper core filter through which air after filtration exits,
wherein the plurality of second supports is positioned side by side in the housing so as to form multiple filtration states in the paper core filter and thereby facilitate the flow of foreign substances to be discharged.

20. The filter assembly of claim 19, wherein the first support and the plurality of second supports are combined into a single removable unit by at least one coupling structure that interconnects the first support and the second supports, allowing the paper core filter and its supports to be replaced or removed from the housing as one integrated assembly.
